(19) United States
(12) Patent Application Publication
(10) Pub. No.: US 2010/0241990 A1
(43) Pub. Date: Sep. 23, 2010

(54) RE-USABLE DECLARATIVE WORKFLOW TEMPLATES

(75) Inventors: Sean K. Gabriel, Bellevue, WA (US); Alexander Malek, Seattle, WA (US); Gabriel J. Hall, Woodinville, WA (US); Phillip D. Allen, Kirkland, WA (US); Mahesh Balasubramanian, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/409,346

(22) Filed: Mar. 23, 2009

(51) Int. Cl. G06F 15/16; G06F 3/048

(52) U.S. Cl. 715/810; 709/203; 715/234; 709/230; 709/226

(57) ABSTRACT

A server computing system stores at least one workflow template and at least one workflow customization table. The workflow template includes activity elements that indicate activities included in the workflow. The activity elements include attributes associated with input properties of the indicated activities. At least one of the activity elements includes an attribute associated with an input property, the attribute specifying a variable name, not particular data. The workflow customization table includes an entry associating the variable name with particular data. When the server computing system initializes a workflow instance based on the workflow template, the server computing system binds the input property to the particular data specified by the workflow customization table. Thus, by storing different workflow customization tables, the same workflow template can be used to initialize workflow instances having different behavior.

### BACKGROUND

A business process is a structured set of tasks performed by an enterprise to accomplish a concrete business objective. In many instances, the performance of business processes constitutes the routine operation of an enterprise. For example, an enterprise may perform a business process in which employees of the enterprise submit reimbursement requests for travel expenses. In this example, a supervisor reviews each reimbursement request. If, in this example, the supervisor approves a reimbursement request, an accounts payable department of the enterprise writes a check to the employee. If, in this example, the supervisor disapproves a reimbursement request, an email message is sent to the employee notifying the employee that the reimbursement request was denied.

Workflows are computerized implementations of business processes. A workflow comprises a set of activities. Each activity in a workflow corresponds to a task in a business process. Each activity in a workflow comprises a modular set of computer-executable code that implements the activity. When a computer executes an instance of a workflow, the computer executes the computer-executable code implementing activities in the workflow.

Individual activities in a workflow are modular in the sense that the activities are not dependent on one another to operate correctly. Such modularity enables the same activity to be reused in different workflows. To receive outside information, individual activities have input properties. When a workflow is designed, the input properties of the activities are bound to specific data or data sources. In this way, when the workflow is designed, each activity is able to receive the outside data the activity needs to execute.

### SUMMARY

A server computing system stores at least one workflow template and at least one workflow customization table. The workflow template includes activity elements that indicate activities included in the workflow. The activity elements include attributes associated with input properties of the indicated activities. At least one of the activity elements includes an attribute associated with an input property, the attribute specifying a variable name, not particular data. The workflow customization table includes an entry associating the variable name with particular data. When the server computing system initializes a workflow instance based on the workflow template, the server computing system binds the input property to the particular data specified by the workflow customization table. Thus, by storing different workflow customization tables, the same workflow template can be used to initialize workflow instances having different behavior.

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a block diagram illustrating an example workflow.

FIG. 3 is a block diagram illustrating example logical components of a server computing system.

FIG. 4 is a block diagram illustrating example logical components of a client computing system.

FIG. 5 is a flowchart illustrating an example operation of the server computing system.

FIG. 6 is a flowchart illustrating an example operation of the client computing system to design a workflow template using a declarative workflow design application.

FIG. 7 is a flowchart illustrating an example operation of the client computing system to design a workflow customization table.

FIG. 8 is a block diagram illustrating example physical components of an electronic computing device.

### DETAILED DESCRIPTION

As briefly described above, the present disclosure describes re-usable declarative workflows. This disclosure discusses the attached figures. It will be appreciated that the figures are provided for purposes of explanation only and do not represent a sole way of practicing the technologies of this disclosure. Reference numerals in this disclosure refer to equivalent reference numerals in the figures.

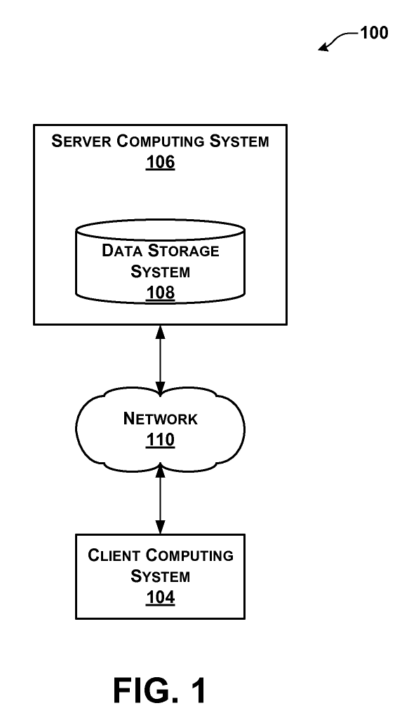

FIG. 1 is a block diagram illustrating an example system 100. It is to be understood that system 100 is merely one example. The techniques of this disclosure may be implemented in many other ways. For instance, other systems implementing the techniques of this disclosure may include more or fewer components, systems, connections, and so on.

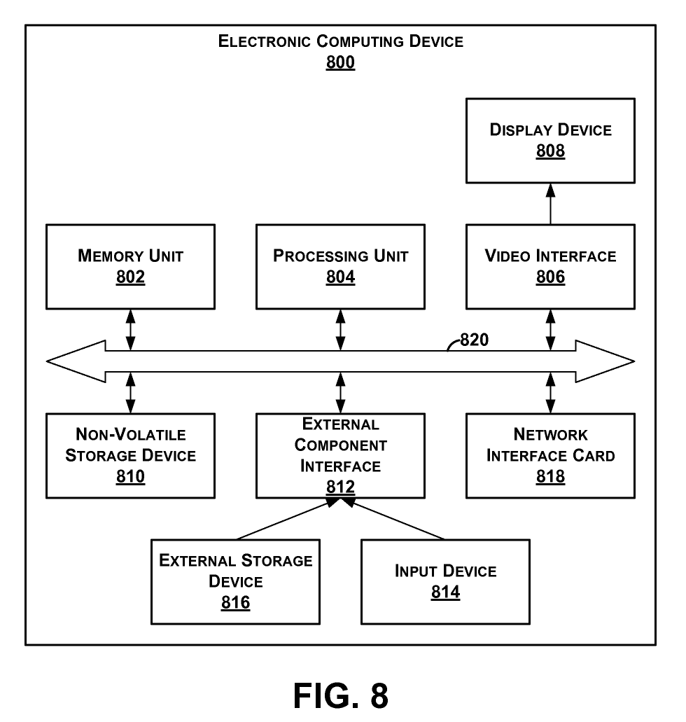

As illustrated in the example of FIG. 1, system 100 includes a client computing system 104. Client computing system 104 is an electronic computing system. As used in this disclosure, an electronic computing system is a set of one or more electronic computing devices. This disclosure describes details of an example electronic computing device with reference to FIG. 8. Client computing system 104 may include a wide variety of different types of electronic computing devices. For example, client computing system 104 may include a personal computer, a mobile telephone, a personal digital assistant (PDA), a digital media player, a television set top box, a television, a home appliance, an industrial appliance, a device integrated into a vehicle, a video game console, an Internet kiosk, a netbook, a laptop computer, a handheld video game device, an intermediate network device, a standalone server device, a server blade device, a network storage device, an Automated Teller Machine, a wearable computing device or another type of electronic computing device.

In addition to client computing system 104, system 100 includes a server computing system 106. Server computing system 106 is an electronic computing system. Like client computing system 104, server computing system 106 may include a wide variety of different types of electronic computing devices. For instance, server computing system 106 may include any of the types of electronic computing devices described above.

System 100 also includes a network 110. Network 110 is an electronic communication network. Network 110 facilitates electronic communication between client computing system 104 and server computing system 106. Network 110 may be implemented in a variety of ways. For example, network 110 may be a wide-area network, such as the Internet. In other examples, network 110 may be a local-area network, a metropolitan-area network, or another type of electronic communication networks. Network 110 may include wired and/or wireless data links. A variety of communications protocols may be used in network 110. Such communications protocols include, but are not limited to, Ethernet, Transmission Control Protocol (TCP), Internet Protocol (IP), Hypertext Transfer Protocol (HTTP), SOAP, remote procedure call (RPC) protocols, user datagram protocol (UDP), IPSec, Resource Reservation Protocol (RSVP), Internet Control Message Protocol (ICMP) and/or other types of communications protocols.

Server computing system 106 is configured to execute workflow instances. As used in this disclosure, a workflow instance is an instance of a workflow. A workflow is a computerized implementation of a business process. A business process is a structured set of tasks performed by an enterprise to accomplish a concrete business objective. For example, a workflow may be a computerized implementation of a business process to approve travel expenses. In this example, the concrete business objective is predictable approval or disapproval of travel expenses to manage costs and ensure accountability. Furthermore, in this example, the business process may include tasks such as receiving an expense report, providing the expense report to a reviewer for review, receiving approval of the expense report, cutting a check, and so on. As used in this disclosure, an enterprise is a business organization, a governmental organization, a non-government organization, an individual, a non-profit organization, or another type of natural or legal entity.

A workflow comprises a structured set of activities. Each activity in a workflow comprises a modular set of computer-executable instructions that, when executed by a computing system, cause the computing system to perform a task in a business process. For example, an activity in a workflow may comprise a modular set of computer-executable instructions that, when executed by a computing system, cause the computing system to provide an expense report to a reviewer for review. The sets of computer-executable instructions in activities are modular in the sense that the sets are not dependent on one another to operate correctly. Such modularity enables the same activity to be reused in different workflows.

Each activity in a workflow has one or more input properties. An activity receives external information through its input properties. In a first example implementation, activities are implemented as software objects. In this example, the input properties of activities are parameters of the constructor methods of the activities. In other example implementations where activities are implemented as software objects, input properties may be parameters passed to setter methods of the activities or objects assigned to public properties of the activities.

A wide variety of external information can be passed to an activity via the activity's input properties. For example, an activity may perform a particular operation on data in a list object. As used in this disclosure, a list object is a table of arbitrary data. For instance, a list object may be a table containing birthdates for all employees of an enterprise. In this example, the activity may send a greeting e-mail to persons associated with dates matching the current date. In this example, a reference to this birthday list can be passed to the activity via an input property of the activity. In this way, the activity causes a computing system to send greeting e-mails to employees on their birthdays. In this example, a reference to a list of client's birthdays can be passed to the activity in order to cause the computing system to send greeting e-mails to clients on their birthdays. In a second example, an activity in a travel expense approval workflow may send an e-mail to a reviewer. In this second example, the e-mail address of the reviewer can be passed to the activity via an input property of the activity.

In some instances, it may not be desirable to assign data to input properties of activities when a workflow containing the activities is designed. For example, in the travel expense approval workflow discussed in the previous paragraph, it might not be desirable to assign the e-mail address of the reviewer to the input property of the activity when the travel expense approval workflow is designed. In this example, two different departments of an enterprise may have two different reviewers for travel expenses. Consequently, in this example, if the e-mail address of the reviewer is set when the travel expense workflow is designed, separate travel expense workflows would have to be designed for the two departments.

To avoid such situations, a workflow template can be designed. As used in this disclosure, a workflow template is a workflow in which at least one input property of at least one activity in the workflow is assigned to a variable name. The variable name is simply a placeholder for data that will eventually be bound to the input property. In the travel expense example discussed above, the string “Reviewer_Email” may be a variable name temporarily assigned to the input property of the activity that sends an e-mail to the reviewer.

As described in greater detail below, a user is able to generate one or more workflow customization tables for a single workflow template. A workflow customization table includes entries that associate variable names with particular data. It should be noted that the particular data may be explicit data, a data source, or another type of data. For example, a first workflow customization table associated with the travel expense workflow may include an entry that associates the variable name “Reviewer_Email” with the data “bob@contoso.com.” In this example, a second customization table associated with the travel expense workflow may include an entry that associates the variable name “Reviewer_Email” with the data “anoop@contoso.com.”

When server computing system 106 initializes a workflow for execution, server computing system 106 uses an appropriate workflow customization table to replace the variable names of the input properties with the particular data specified by entries in the appropriate workflow customization table. In the travel expense workflow example discussed above, server computing system 106 may use the first workflow customization table when initializing the travel expense workflow for the first department and may use the second workflow customization table when instantiating the travel expense workflow for the second department. As a result, server computing system 106 sends e-mails for the first department to “bob@contoso.com” and sends e-mails for the second department to “anoop@contoso.com.”

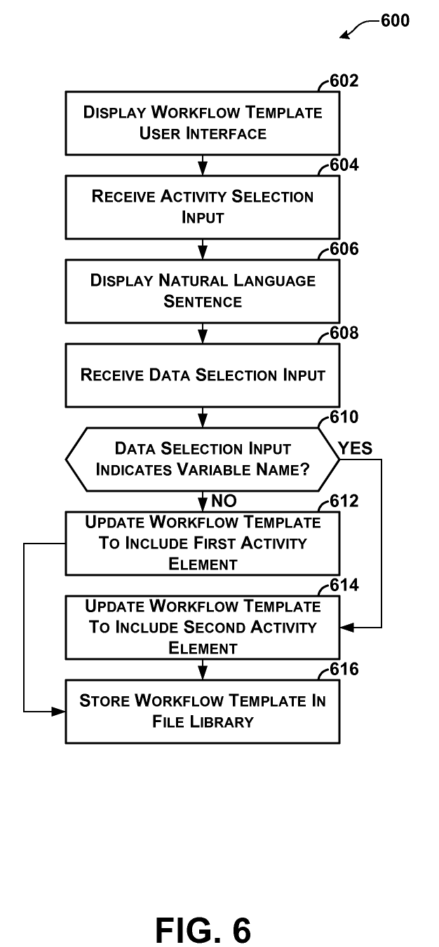

As described below with reference to FIG. 6, a user of client computing system 104 interacts with client computing system 104 to design a workflow template using a declarative workflow design application. A declarative workflow design application is an application that enables a user to design a workflow or a workflow template using natural language sentences that express business process tasks performed by activities. For example, a declarative workflow design application may display the following sentence: “Send an email message to ______.” In this example, the sentence expresses the task of sending an e-mail message. A specific activity implements this task, but the user does not need to know how anything about how the specific activity is added to the workflow or how the specific activity operates. In other words, implementation details of the activity are hidden from the user. In this example, the user can insert an e-mail address in the underscored blank. Furthermore, in this example, the user can insert a variable name in the underscored blank, thereby leaving the input property associated with the underscored blank to be provided by a workflow customization table when the workflow is instantiated.

When the user of client computing system 104 designs a workflow template or a workflow, client computing system 104 stores the workflow template or workflow at a data storage system 108 at server computing system 106. As used in this disclosure, a data storage system is a collection of one or more computer-readable data storage media. For example, a data storage system may comprise a plurality of hard disk drives. In another example, a data storage system may comprise a CD-ROM disc and a random-access memory unit.

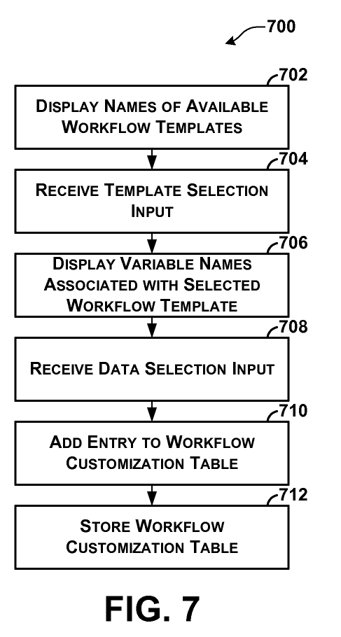

As explained below with reference to FIG. 7, the user of client computing system 104 interacts with client computing system 104 to design workflow customization tables. In one example implementation, the declarative workflow design application discussed above may include functionality enabling the user to design workflow customization tables. When the user of client computing system 104 finishes designing a workflow customization table, client computing system 104 stores the workflow customization table at data storage system 108 at server computing system 106.

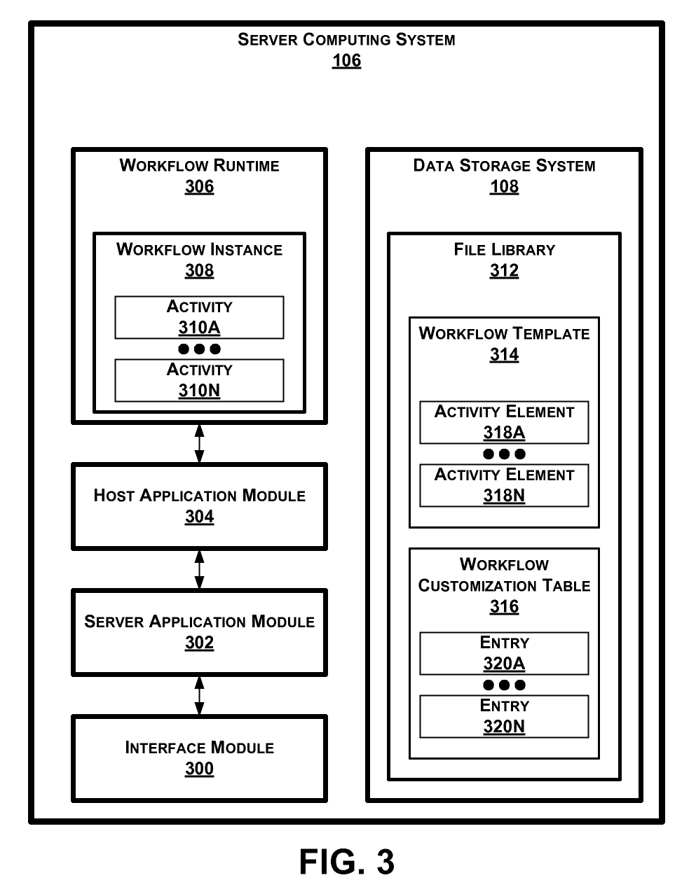

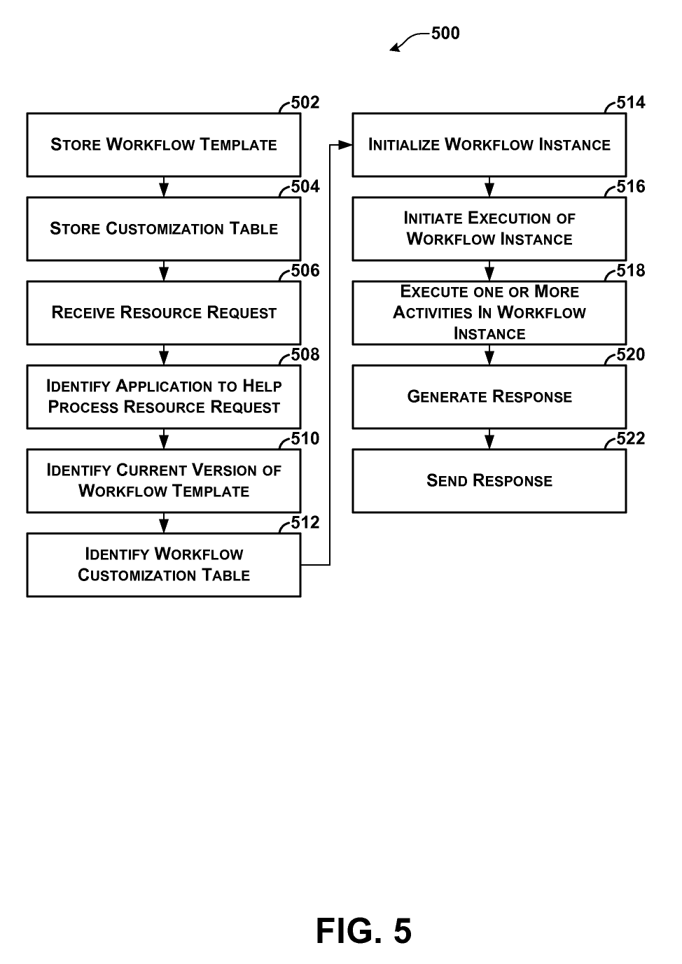

In the example of FIG. 1, the user of client computing system 104 also interacts with client computing system 104 to cause client computing system 104 to send resource requests to server computing system 106. For example, client computing system 104 may send a HTTP request to server computing system 106. As described below with reference to FIGS. 3 and 5, server computing system 106 may instantiate and execute workflows in response to resource requests from client computing system 104.

It should be appreciated that FIG. 1 is provided for explanatory purposes only. In other examples, system 100 may include many other computing systems. For example, system 100 could include a large number of client computing systems. Moreover, the functionality described above with regard to client computing system 104 may be distributed among several client computing systems. For instance, a user of a first client computing system may design a workflow template, a user of a second client computing system may design a workflow customization table, and a user of a third client computing system may send resource requests to server computing system 106. In another example, functionality described above as occurring at client computing system 104 may occur at server computing system 106. For instance, a user of server computing system 106 may design a workflow template or a resource request may originate at server computing system 106. Consequently, the disclosure may refer to a design computing system at which the user designs workflow templates or workflow customization tables.

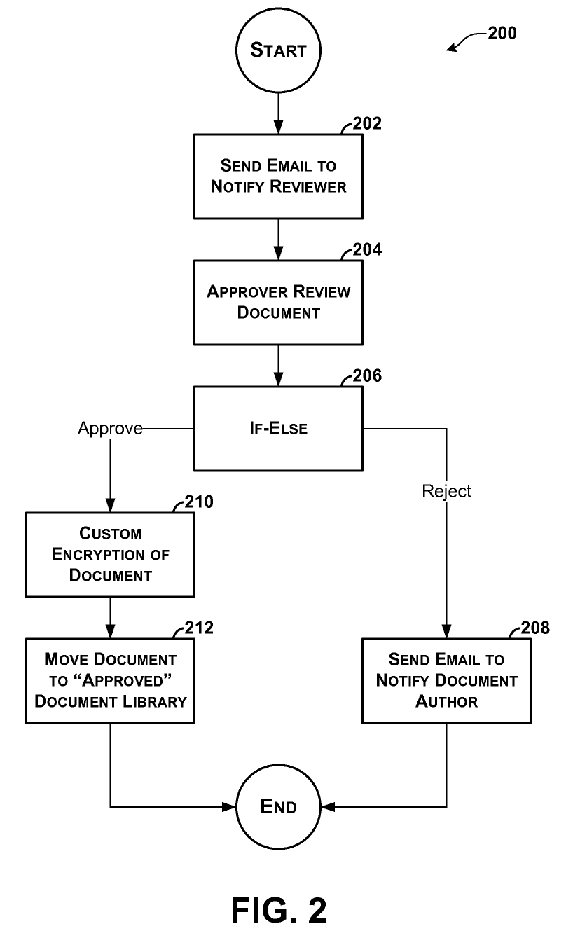

FIG. 2 is a block diagram illustrating an example workflow 200. It should be appreciated that workflow 200 is provided for purposes of explanation only. Workflow 200 is not intended to be interpreted as a sole workflow that can be used in system 100.

In the example of FIG. 2, workflow 200 implements a business process for approving a document. At activity 202, an e-mail is sent to a reviewer notifying the reviewer that an author has added a document to an “unapproved” document library. Next, at activity 204, an approver reviews the document. At activity 206, it is automatically determined whether the approver approved the document or rejected the document. If the approver rejected the document, an e-mail is sent to the author at activity 208, the e-mail notifying the author that the approver rejected document. If the approver approved the document, a custom encryption operation is performed on the document at activity 210. After the custom encryption operation is performed on the document, the document is moved to an approved document library at activity 212. After activity 208 or activity 212, workflow 200 ends.

FIG. 3 is a block diagram illustrating example logical components of server computing system 106. It should be appreciated that logical components in FIG. 3 are provided for explanatory purposes only and not intended to represent a sole way of logically organizing server computing system 106. Rather, many other logical organizations of server computing system 106 are possible.

As illustrated in the example of FIG. 3, server computing system 106 comprises an interface module 300, a server application module 302, a host application module 304, a workflow runtime 306, a workflow instance 308, and a plurality of activities 310A-310N (collectively, “activities 310”). In addition, server computing system 106 comprises data storage system 108, a file library 312, a workflow template 314, a workflow customization table 316, a plurality of activity elements 318A-318N (collectively, “activity elements 318”), and a plurality of entries 320A-320N (collectively, “entries 320”).

In the example of FIG. 3, file library 312 contains resources of a website. Although not illustrated in the example of FIG. 3 for sake of simplicity, file library 312 may contain a plurality of workflow templates and workflow customization tables. Furthermore, although not illustrated in the example of FIG. 3 for sake of simplicity, data storage system 108 may contain a plurality of file libraries. One or more of the file libraries in data storage system 108 may be nested within another file library in data storage system 108.

In one example implementation, workflow template 314 is an extensible markup language (XML) file. Each one of activity elements 318 is an XML element in this XML file. Activity elements 318 are arranged within the XML file a hierarchy. Each of activity elements 318 specifies an activity to include in a workflow. The position of an activity element within the hierarchy indicates the position within the workflow of the activity specified by the activity element. For example, workflow template 314 may appear as follows:

```
<SequentialWorkflowActivity>
  <ReceiveDocumentActivity/>
  <SendEmailActivity to=”Reviewer_Email”
  from=”admin@contoso.com”/>
  <ReceiveReviewActivity/>
</SequentialWorkflowActivity>
```

In this example, the <SequentialWorkflowActivity> element is an activity that sequentially invokes activities specified by child activity elements of the <SequentialWorkflowActivity> element. Specifically, in this example, the activity specified by the <SequentialWorkflowActivity> element sequentially invokes an activity specified by the <ReceiveDocumentActivity> element, an activity specified by the <SendEmailActivity> element, and an activity specified by the <ReceiveReviewActivity> element. Furthermore, in this example, the <SendEmailActivity> element has two attributes: “to” and “from.” The variable name “Reviewer_Email” is assigned to the “to” attribute and the e-mail address “admin@contoso.com” is assigned to the “from” attribute. In this disclosure, a customizable activity element is an activity element that includes an attribute assigned to a variable name. Furthermore, a customizable activity is an activity specified by a customizable activity element. In the above example, the <SendEmailActivity> element is a customizable activity element. It should be appreciated that workflow template 314 and activity elements 318 may be represented in ways other than XML. For example, workflow template 314 and activity elements 318 may be represented as a relational database table containing database entries.

Interface module 300 enables server computing system 106 to communicate on network 110 (FIG. 1). For instance, interface module 300 enables server computing system 106 to send and receive network protocol messages from client computing system 104 (FIG. 1). When interface module 300 receives a resource request, interface module 300 provides the resource request to server application module 302.

Server application module 302 is a network server application. For example, server application module 302 may be an instance of the Internet Information Services (IIS) server created by Microsoft Corporation. When server application module 302 receives a resource request, server application module 302 identifies an application to help process the resource request. Upon identifying the application to help process the resource request, server application module 302 sends a request to the identified application. In the example of FIG. 3, server application module 302 sends the request to host application module 304.

Host application module 304 helps process resource requests received by server application module 302. For example, host application module 304 may be an ASP.NET web application. Host application module 304 may help process resource requests in a variety of ways. In the example of FIG. 3, host application module 304 helps process resource requests using workflows.

To use a workflow to help process a resource request, host application module 304 instantiates workflow instance 308 in workflow runtime 306. Workflow runtime 306 is an operating environment that manages workflow instances. When host application module 304 instantiates workflow instance 308, host application module 304 may identify workflow template 314 and workflow customization table 316 to workflow runtime 306. In response, workflow runtime 306 retrieves workflow template 314 and workflow customization table 316 from data storage system 108. After retrieving workflow template 314 and workflow customization table 316, workflow runtime 306 uses activity elements 318 in workflow template 314 to instantiate activities indicated by activity elements 318. In the example of FIG. 3, activities 310 are the instantiated activities indicated by activity elements 318. After instantiating activities 310, workflow runtime 306 sets input properties of activities 310 specifying variable names to particular data indicated by entries 320 in workflow customization table 316.

Once workflow instance 308 is fully instantiated, host application module 304 is able to instruct workflow runtime 306 to initiate execution of workflow instance 308. As described in greater detail with reference to FIG. 5, when server computing system 106 executes one or more activities of workflow instance 308, server computing system 106 generates data used by host application module 304 to help process the resource request received by server application module 302. Eventually, host application module 304 returns data to server application module 302 that server application module 302 uses in a response to the resource request. Interface module 300 sends the response back to the sender of the resource request.

In this disclosure, interface module 300, server application module 302, host application module 304, workflow runtime 306, workflow instance 308 and activities 310 are referred to as functional modules of server computing system 106. The functional modules of server computing system 106 may be implemented in a wide variety of ways. In a first example, one or more of the functional modules of server computing system 106 may be implemented as sets of instructions stored at a data storage system. In this first example, a processing unit within server computing system 106 may execute the sets of instructions, thereby causing server computing system 106 to perform the behaviors associated with one or more of the functional modules of server computing system 106. As used in this disclosure, a processing unit is a set of one or more physical electronic integrated circuits that are capable of executing instructions. In a second example, one or more of the functional modules of server computing system 106 are implemented as one or more application-specific integrated circuits (ASICs). The ASICs cause server computing system 106 to perform the behaviors associated with one or more of the functional modules of server computing system 106. In this second example, the ASICs may be specifically designed to perform the behaviors associated with one or more of the functional modules of server computing system 106.

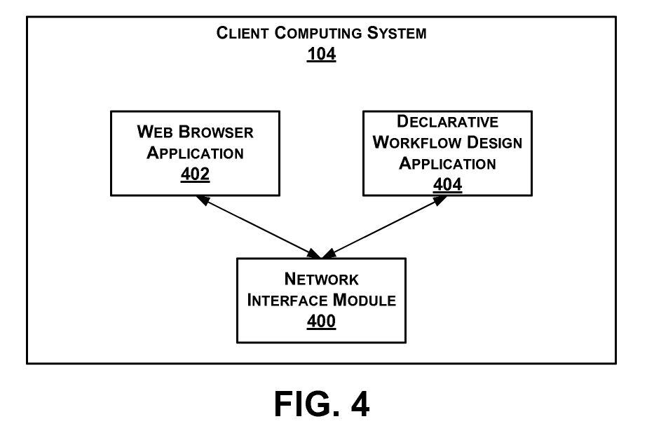

FIG. 4 is a block diagram illustrating example logical components of client computing system 104. It should be appreciated that logical components in FIG. 4 are provided for explanatory purposes only and not intended to represent a sole way of logically organizing client computing system 104. Rather, many other logical organizations of client computing system 104 are possible.

As illustrated in the example of FIG. 4, client computing system 104 comprises a network interface module 400, a web browser application 402, and a declarative workflow design application 404. Network interface module 400 enables client computing system 104 to communicate on network 110 (FIG. 1). For example, network interface module 400 enables client computing system 104 to send and receive communication protocol messages on network 110. Web browser application 402 enables a user to interact with client computing system 104 to cause client computing system 104 to retrieve resources available on network 110 and to display certain types of resources. Declarative workflow design application 404 is an instance of a declarative workflow design application of the type described above with regard to FIG. 1 and below with regard to FIGS. 6 and 7.

In this disclosure, network interface module 400, web browser application 402 and declarative workflow design application 404 are referred to as functional modules of client computing system 104. The functional modules of client computing system 104 may be implemented in a wide variety of ways. In a first example, one or more of the functional modules of client computing system 104 may be implemented as sets of instructions stored at a data storage system. In this first example, a processing unit within client computing system 104 may execute the sets of instructions, thereby causing client computing system 104 to perform the behaviors associated with one or more of the functional modules of client computing system 104. In a second example, one or more of the functional modules of client computing system 104 are implemented as one or more ASICs. The ASICs cause client computing system 104 to perform the behaviors associated with one or more of the functional modules of client computing system 104. In this second example, the ASICs may be specifically designed to perform the behaviors associated with one or more of the functional modules of client computing system 104.

FIG. 5 is a flowchart illustrating an example operation of server computing system 106. It should be appreciated that operation 500 is merely an example operation of server computing system 106. Many other operations of server computing system 106 are possible. For instance, other operations of server computing system 106 may include more or fewer steps. In other instances, operations of server computing system 106 may include the steps of operation 500 in different orders.

As illustrated in the example of FIG. 5, operation 500 begins when workflow template 314 (FIG. 3) is stored in file library 312 of data storage system 108 (502). As described below with reference to FIG. 6, a user of client computing system 104 may store workflow template 314 in file library 312 after the user designs workflow template 314. Next, a workflow customization table 316 is stored in file library 312 of data storage system 316 (504). As described below with reference to FIG. 7, a user of client computing system 104 may store workflow customization table 316 in file library 312 after the user designs workflow customization table 316.

After workflow template 314 and workflow customization table 316 are stored in file library 312 of data storage system 108, server application module 302 receives a resource request (506). In one example, server application module 302 may receive the resource request from interface module 300 and interface module 300 may have received the resource request from client computing system 104 via network 110. The resource request may request a wide variety of resources. For example, the resource request may be a request for a web page, a request to synchronize e-mail mail boxes, a RPC request for execution of a specific procedure, a request for a media stream, or a request for another type of resource.

In response to receiving the resource request, server application module 302 identifies an application to help process the resource request (508). For example, a plurality of web applications may operate at server computing system 106, each associated with different domain names. In this example, server application module 302 may use a domain name specified by the resource request to identify one of the web applications. In other examples, server application module 302 may use a variety of other techniques to identify an application to help process the resource request. For instance, server application module 302 may use a lookup table or a configuration file to identify an application to help process the resource request. Applications may help server application module 302 process resource requests in a variety of ways. For example, applications may help server application module 302 process resource requests by generating content, retrieving data, storing data, executing scripts, and/or performing other activities. In the example of FIG. 5, it is assumed that server application module 302 identifies host application module 304 as the application to help process the resource request.

After being identified as an application to help process the resource request, host application module 304 identifies a current version of a workflow template needed to process the resource request (510). Host application module 304 may identify a current version of the workflow template in a variety of ways. For instance, as time passes, users may create new versions of workflow templates. However, when a user creates a new version of a workflow template, instances of the existing version of the workflow template may still be active. Creating the new version of the workflow does not cause the instances of the existing version of the workflow template to terminate. For this reason, host application module 304 may use a version number of workflow templates to identify the current version of the workflow template.

After identifying the current version of the workflow template, host application module 304 identifies an appropriate workflow customization table to use with the workflow template (512). Host application module 304 may identify the appropriate customization table in a variety of ways. For example, data storage system 108 may store data associating individual workflow customization tables with different web sites, site groups, list objects, list content types, or other groups of data. In this example, host application module 304 may use the data to identify the workflow customization table associated with the resource requested by the resource request.

After identifying the appropriate workflow customization table, host application module 304 initializes workflow instance 308 (514). In one example implementation, host application module 304 may initialize workflow instance 308 by invoking a method of workflow runtime 306. In this example implementation, host application module 304 may provide a reference to a workflow template and a reference to a workflow customization table as parameters when host application module 304 invokes the method of workflow runtime 306. In this way, host application module 304 identifies to workflow runtime 306 which workflow template and which workflow customization table to use to generate workflow instance 308. For instance, host application module 304 may provide a reference to workflow template 314 and a reference to workflow customization table 316 as parameters to the method of workflow runtime 306.

During the initialization of workflow instance 308, workflow runtime 306 interprets the specified workflow template and instantiates each activity specified by the activity elements of the specified workflow template. For example, if workflow template 314 is the specified workflow template, workflow runtime 306 instantiates one of activities 310 for each of activity elements 318 in workflow template 314. To instantiate an activity, workflow runtime 306 may invoke a constructor method of the activity. After instantiating activities 310, workflow runtime 306 may use entries 320 to bind particular data to input parameters of activities 310. For example, assume the following represents activity element 318A: “<EmailActivity reviewer=“Reviewer_Email”>”. In this example, “Reviewer_Email” is a variable name. Furthermore, assume that entry 320A specifies “Reviewer_Email” maps to “dnoriega@contoso.com.” In this example, workflow runtime 306 instantiates an EmailActivity activity (e.g., activity 310A) and sets a reviewer input property of the EmailActivity activity to “dnoriega@contoso.com.”

In some example implementations, when workflow runtime 306 initializes workflow instance 308, workflow runtime 306 may bind contextual data to input parameters of activities 310. This contextual data is not defined in workflow template 314. Rather, the contextual data is defined by a context in which host application module 304 initializes workflow instance 308. The contextual data may be defined in or derived from in a variety of other sources. For example, when host application module 304 invokes the method of workflow runtime 306 to initialize workflow instance 308, host application module 304 may pass to workflow runtime 306 contextual data to be bound to one or more input parameters of activities 310. In a second example, workflow runtime 308 may bind contextual data to input parameters of activities 310 based on a scope associated with workflow template 314. In this second example, workflow instance 308 may operate within the context of a web page, a web site, a group of web sites, or a server farm. In this second example, the web page, the web site, the group of web site, and the server farm are examples of scopes that may be associated with workflow instance 308. Each scope, in this second example, may be associated with different data to be bound to input parameters of activities 310. This in third example, the scope associated with workflow instance 308 may be determined based on a variety of factors. For instance, the scope associated with workflow instance 308 may be determines based on a location (e.g., document library) at which workflow template 314 is stored. In a third example, workflow runtime 306 may bind contextual data to input parameters of activities 310 based on an event that caused host application module 304 to initialized workflow instance 308. For instance, in this third example, host application module 304 may initialize workflow instance 308 in response to receiving a request for a first web page or a second web page. In this instance, workflow runtime 306 may bind different contextual data to workflow instance 308 depending on whether the first web page or the second web page was requested.

As mentioned above, users may create new versions of workflow templates. When workflow runtime 306 initializes a workflow instance based on the new version of a workflow template, workflow runtime 306 associates a tombstone with the workflow customization table associated with the previous version of the workflow template. The tombstone indicates that no new instances of workflows are to be generated with the workflow customization table associated with the previous version of the workflow template. Workflow runtime 306 then creates a new version of the workflow customization table and associates the new version of the workflow customization table with the new version of the workflow template. Workflow runtime 306 then initializes the new version of the workflow template using the new version of the workflow customization table. In this way, instances of the previous version of the workflow template can continue to use the workflow customization table associated with the previous version of the workflow template until completion.

After host application module 304 initializes workflow instance 308, host application module 304 initiates execution of workflow instance 308 (516). In one example implementation, host application module 304 may initiate execution of workflow instance 308 by invoking a start method of workflow instance 308. It should be noted that host application module 304 does not necessarily initialize and initiate execution of a new workflow instance in response to all resource requests. In some instances, host application module 304 may provide additional information to existing workflow instances in response to a resource request.

In response to workflow instance 308 initiating execution of workflow instance 308, server computing system 106 executes one or more activities 310 in workflow instance 308 (518). During execution of activities in workflow instance 308, server computing system 106 uses data bound to input properties of the activities to execute the activities. For example, if workflow runtime 306 binds the e-mail address “dnoriega@contoso.com” to the reviewer input property of the EmailActivity activity as described in the above example, server computing system 106 uses the e-mail address “dnoriega@contoso.com” during execution of the EmailActivity activity.

After server computing system 106 executes one or more activities 310 in workflow instance 308, server application module 302 generates a response to the resource request (520). The response may include data generated during execution of the one or more activities of workflow instance 308. For instance, the response may include data retrieved from a database by one of the activities in the workflow instance 308. In other circumstances, the response does not include any data generated during execution of the one or more activities of workflow instance 308. It should be appreciated that workflow instance 308 may not run to completion before server application module 302 generates the response. Rather, workflow instance 308 may continue operating asynchronously from server application module 302. For instance, workflow instance 308 may continue operating when workflow instance 308 is an instance of a long-running workflow whose activities occur over the course of several days.

After server application module 302 generates the response, interface module 300 sends the response to a sender of the resource request (522). For example, if client computing system 104 sent the resource request, interface module 300 sends the response to client computing system 104.

FIG. 6 is a flowchart illustrating an example operation of client computing system 104 to design a workflow template using declarative workflow design application 404. It should be appreciated that operation 600 is merely an example operation of client computing system 104. Many other operations of client computing system 104 are possible. For instance, other operations of client computing system 104 may include more or fewer steps. In other instances, operations of client computing system 104 may include the steps of operation 600 in different orders.

Initially, declarative workflow design application (“DWDA”) 404 (FIG. 4) in client computing system 104 displays a workflow template user interface (602). The workflow template user interface is a graphical user interface (GUI) that enables the user of client computing system 104 to design a workflow template. The workflow template user interface contains available activity names. Each of the available activity names is a name of an activity available to be included in a workflow. For example, the workflow template user interface may include the following available activity names: “Send Email,” “Request Review,” “Encrypt File,” “Transfer File to Document Archive,” and so on.

After displaying workflow template user interface, DWDA 404 receives activity selection input (604). The activity selection input indicates a selected available activity name from among the available activity names contained in the workflow template user interface. The selected available activity name is the name of a selected available activity. For example, the activity selection input may indicate that the user has selected “Send Email” from among the available activity names contained in the workflow template user interface.

In response to receiving the activity selection input, DWDA 404 displays a natural language sentence in the workflow template user interface (606). The natural language sentence expresses a business process task to be performed when the selected activity is executed. For example, DWDA 404 may display the following natural language sentence in response to the user selecting “Send Email” from among the available activity names: “Send an e-mail message from ______ to ______.” In circumstances where the selected activity has an input property to be specified by the user, the natural language sentence includes an input feature enabling the user to select particular data to be bound to the input property or to select a variable name. In the previous example, the selected “Send Email” activity has two input properties to be specified by the user. Consequently, in this example, the natural language sentence includes two input features, indicated by the underscored blanks. In other examples, the input features may be text boxes, drop boxes, radio buttons, check boxes, dials, menus, command icons, or other types of user input controls.

After displaying the natural language sentence in the workflow template user interface, DWDA 404 receives data selection input from the user via an input feature of the natural language sentence (608). The data selection input indicates an input that the user entered into the input feature. In response to receiving the data selection input, DWDA 404 determines whether the data selection input indicates a variable name (610). DWDA 404 may determine whether the data selection input indicates a variable name in a variety of ways. For example, DWDA 404 may determine that the data selection input indicates a variable name when the data selection input is a string that does not conform to an expected data type for the input property. For instance, DWDA 404 may assume that the data selection input indicates a variable name when the data selection input is a string that is not an e-mail address.

In response to determining that the data selection input does not indicate a variable name (“NO” of 610), DWDA 404 updates the workflow template such that the activity elements in the workflow template include a first activity element (612). In other words, in response to determining that the data selection input indicates that the user has selected particular data to be bound to the input property, DWDA 404 updates the workflow template such that the activity elements in the workflow template include a first activity element. The first activity element indicates the selected activity. The first activity element includes an attribute associated with the input feature of the selected activity. The attribute specifies the particular data to be bound to the input property. In the above example, the data selection input from the “to” input feature may indicate the particular data “cook@contoso.com.” In this example, DWDA 404 may update the workflow template to include the following activity element: “<SendEmailActivity to=“cook@contoso.com” from=“kelly@contoso.com”>.” In this example, the data selection input indicates the particular data “cook@contoso.com” is assigned to the attribute associated with the “to” input property.

On the other hand, in response to determining that the data selection input indicates a variable name (“YES” of 610), DWDA 404 updates the workflow template such that the activity elements in the workflow template include a second activity element (614). The second activity element indicates the selected activity. The second activity element includes an attribute associated with the input feature of the selected activity. The attribute specifies the variable name indicated by the data selection input. In the above example, the data selection input from the “to” input feature may indicate the variable name “Email_Variable.” In this example, DWDA 404 may update the workflow template to include the following activity element: “<SendEmailActivity to=“Email_Variable” from=“kelly@contoso.com”>.” In this example, the data selection input indicates the variable name “Email_Variable” will be replaced by particular data when the workflow template is initialized.

After updating the workflow template in steps 612 or 614, DWDA 404 stores the workflow template in a file library at server computing system 106 (616). It should be appreciated that before DWDA 404 stores the workflow template in the file library, the steps of operation 600 may be repeated an indefinite number of times to build a complete workflow template. As mentioned briefly above, data storage system 108 at server computing system 106 may include a plurality of file libraries. Each of the file libraries contains the resources of a website. The file libraries can be nested within one another. For example, a first file library may contain a second file library and a third file library. In this example, the first file library may contain the resources of a website for an entire enterprise, the second file library may contain the resources of a website for a first department of the enterprise, and the third file library may contain the resources of a website for a second department of the enterprise.

The user may cause DWDA 404 to store the workflow template in particular ones of the file libraries in data storage system 108. In the previous example, the user may cause DWDA 404 to store the workflow template in the first file library, the second file library, or the third file library. The file libraries at which the user may store the workflow template may be governed by permission rules. As described below with reference to FIG. 7, storing a workflow template in a particular file library may, in one example implementation, cause the workflow template to be available for use with resources in the website associated with the particular file library and websites associated with file libraries nested within the particular file library.

FIG. 7 is a flowchart illustrating an example operation of client computing system 104 to design a workflow customization table. It should be appreciated that operation 700 is merely an example operation of client computing system 104. Many other operations of client computing system 104 are possible. For instance, other operations of client computing system 104 may include more or fewer steps. In other instances, operations of client computing system 104 may include the steps of operation 700 in different orders.

In the example of FIG. 7, operation 700 begins when DWDA 404 presents a user interface that displays a list containing names of available workflow templates (702). The workflow templates named in the list may depend on the file library in which the user stores the workflow customization table. For example, data storage system 108 (FIG. 3) may store a first file library that includes a second file library and a third file library. In this example, if the user stores the workflow customization table in the second file library, the workflow templates named in the list may include each workflow template stored in the first file library and the second file library, but not the third file library. Similarly, in this example, if the user stores the workflow customization table in the third file library, the workflow templates named in the list may include each workflow template stored in the first file library and the third file library, but not the second file library.

After displaying the user interface, DWDA 404 receives template selection input from the user via the user interface (704). The template selection input indicates a selected workflow template in the list of available workflow templates.

In response to receiving the template selection input, DWDA 404 displays in the user interface variable names associated with the selected workflow template (706). For example, if the selected workflow template includes activity elements having attributes specifying the variable names “Email_Variable,” “Mailing_List_Variable,” and “Input_List_Variable,” DWDA 404 displays these variable names in the user interface.

After displaying a variable name in the user interface, DWDA 404 receives data selection input from the user via the user interface (708). The data selection input indicates data to be bound to the variable name. In the previous example, the data selection input may indicate that the e-mail address “justin@contoso.com” is to be bound to the variable name “Email_Variable.”

In response to receiving the data selection input, DWDA 404 adds an entry to the workflow customization table (710). The entry specifies the particular data to be bound to input properties of activities specified by activity elements having attributes specifying the variable name. In the previous example, the entry may specify that “justin@contoso.com” is to be bound to input properties of activities specified by activity elements having attributes specifying the variable name “Email_Variable.”

After adding the entry to the workflow customization table, DWDA 404 stores the workflow customization table to data storage system 108 at server computing system 106 (712). As mentioned above, DWDA 404 stores the workflow customization table into a file library at data storage system 108. It should be appreciated that multiple workflow customization tables for the same workflow template may be stored in a single file library. Thus, the same workflow template can be re-used for different purposes in the same website.

FIG. 8 is a block diagram illustrating example physical components of an electronic computing device 800. As illustrated in the example of FIG. 8, electronic computing device 800 comprises a memory unit 802. Memory unit 802 is a computer-readable data storage medium capable of storing data and/or instructions. Memory unit 802 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 800 comprises a processing unit 804. As mentioned above, a processing unit is a set of one or more physical electronic integrated circuits that are capable of executing instructions. In a first example, processing unit 804 may execute software instructions that cause electronic computing device 800 to provide specific functionality. In this first example, processing unit 804 may be implemented as one or more processing cores and/or as one or more separate microprocessors. For instance, in this first example, processing unit 804 may be implemented as one or more Intel Core 2 microprocessors. Processing unit 804 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 804 may be implemented as an ASIC that provides specific functionality. In a third example, processing unit 804 may provide specific functionality by using an ASIC and by executing software instructions.

Electronic computing device 800 also comprises a video interface 806. Video interface 806 enables electronic computing device 800 to output video information to a display device 808. Display device 808 may be a variety of different types of display devices. For instance, display device 808 may be a cathode-ray tube display, an LCD display panel, a plasma screen display panel, a touch-sensitive display panel, a LED array, or another type of display device.

In addition, electronic computing device 800 includes a non-volatile storage device 810. Non-volatile storage device 810 is a computer-readable data storage medium that is capable of storing data and/or instructions. Non-volatile storage device 810 may be a variety of different types of non-volatile storage devices. For example, non-volatile storage device 810 may be one or more hard disk drives, magnetic tape drives, CD-ROM drives, DVD-ROM drives, Blu-Ray disc drives, or other types of non-volatile storage devices.

Electronic computing device 800 also includes an external component interface 812 that enables electronic computing device 800 to communicate with external components. As illustrated in the example of FIG. 8, external component interface 812 enables electronic computing device 800 to communicate with an input device 814 and an external storage device 816. In one implementation of electronic computing device 800, external component interface 812 is a Universal Serial Bus (USB) interface. In other implementations of electronic computing device 800, electronic computing device 800 may include another type of interface that enables electronic computing device 800 to communicate with input devices and/or output devices. For instance, electronic computing device 800 may include a PS/2 interface. Input device 814 may be a variety of different types of devices including, but not limited to, keyboards, mice, trackballs, stylus input devices, touch pads, touch-sensitive display screens, or other types of input devices. External storage device 816 may be a variety of different types of computer-readable data storage media including magnetic tape, flash memory modules, magnetic disk drives, optical disc drives, and other computer-readable data storage media.

In addition, electronic computing device 800 includes a network interface card 818 that enables electronic computing device 800 to send data to and receive data from an electronic communication network. Network interface card 818 may be a variety of different types of network interface. For example, network interface card 818 may be an Ethernet interface, a token-ring network interface, a fiber optic network interface, a wireless network interface (e.g., WiFi, WiMax, etc.), or another type of network interface.

Electronic computing device 800 also includes a communications medium 820. Communications medium 820 facilitates communication among the various components of electronic computing device 800. Communications medium 820 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Electronic computing device 800 includes several computer-readable data storage media (i.e., memory unit 802, non-volatile storage device 810, and external storage device 816). Together, these computer-readable storage media may constitute a single data storage system. As discussed above, a data storage system is a set of one or more computer-readable data storage mediums. This data storage system may store instructions executable by processing unit 804. Activities described in the above description may result from the execution of the instructions stored on this data storage system. Thus, when this description says that a particular logical module performs a particular activity, such a statement may be interpreted to mean that instructions of the logical module, when executed by processing unit 804, cause electronic computing device 800 to perform the activity. In other words, when this description says that a particular logical module performs a particular activity, a reader may interpret such a statement to mean that the instructions configure electronic computing device 800 such that electronic computing device 800 performs the particular activity.

The techniques of this disclosure may be realized in many ways. For example, the techniques of this disclosure may be realized as a method for deploying workflows. The method comprises storing a workflow template at a data storage system, the workflow template defining a workflow, the workflow implementing a business process of an enterprise, the workflow comprising a structured set of activities, each activity in the structured set of activities being a modular set of computer-executable instructions that when executed perform a task in the business process, the workflow template comprising a plurality of activity elements, each activity element in the plurality of activity elements indicating an activity in the structured set of activities, the structured set of activities including a customizable activity, the customizable activity having an input property, the plurality of activity elements including a customizable activity element indicating the customizable activity, the customizable activity element including an attribute associated with the input property of the customizable activity, the attribute specifying a variable name. The method also comprises after storing the workflow template, storing a workflow customization table at the data storage system, the workflow customization table including an entry indicating data to be bound to the variable name. In addition, the method comprises after storing the workflow customization table, receiving, at a server computing system, a resource request from a client computing system. Furthermore, the method comprises in response to the resource request, automatically initializing, at the server computer system, a workflow instance, the workflow instance comprising the structured set of activities, the input property of the customizable activity bound to the data indicated by the entry in the workflow customization table. The method also comprises after automatically initializing the workflow instance, automatically initiating, at the server computing system, execution of the workflow instance. In addition, the method comprises during execution of the workflow instance, using, at the server computing system, data bound to the input property of the customizable activity to execute the customizable activity.

In another example, the techniques of this disclosure may be realized as an electronic computing system comprising a processing unit and a data storage system. The data storage system stores a workflow template, the workflow template defining a workflow, the workflow implementing a business process of an enterprise, the workflow comprising a structured set of activities, each activity in the structured set of activities being a modular set of computer-executable instructions that when executed perform a task in the business process, the workflow template comprising a plurality of activity elements, each activity element in the plurality of activity elements indicating an activity in the structured set of activities, the structured set of activities including a customizable activity, the customizable activity having an input property, the plurality of activity elements including a customizable activity element indicating the customizable activity, the customizable activity element including an attribute associated with the input property of the customizable activity, the attribute specifying a variable name. The data storage system also stores a workflow customization table, the workflow customization table including an entry indicating data to be bound to the variable name. In addition, the data storage system stores computer-executable instructions that, when executed by the processing unit, cause the electronic computing system to receive a resource request from a client computing system. In response to the resource request, the instructions cause the electronic computing system to automatically initialize a workflow instance, the workflow instance comprising the structured set of activities, the input property of the customizable activity bound to the data indicated by the entry in the workflow customization table. After automatically initializing the workflow instance, the instructions cause the electronic computing system to automatically initiate execution of the workflow instance. During execution of the workflow instance, the instructions cause the electronic computing system to use data bound to the input property of the customizable activity to execute the customizable activity.

In another example, the techniques of this disclosure may be realized as a computer-readable medium comprising computer-executable instructions that, when executed by a processing unit of an electronic computing system, cause the electronic computing system to display a GUI, the GUI containing a plurality of available activity names, each available activity name in the plurality of available activity names being a name of an activity in a plurality of available activities, each activity in the plurality of available activities being available to be included in a workflow, the workflow implementing a business process of an enterprise, the workflow comprising a structured set of activities, each activity in the structured set of activities being a modular set of computer-executable instructions that when executed perform a task in the business process. The instructions also cause the electronic computing system to receive activity selection input from a user via the GUI, the activity selection input indicating a selected available activity name in the plurality of available activity names, the selected activity name being a name of a selected activity in the plurality of available activities. Furthermore, the instructions cause the electronic computing system to in response to the activity selection input, display a natural language sentence in the GUI, the natural language sentence expressing a task performed when the selected activity is executed, the natural language sentence including an input feature, the input feature enabling the user to select particular data to be bound to an input property of the selected activity or to select a variable name. In addition, the instructions cause the electronic computing system to after displaying the natural language sentence, receive data selection input from the user via the input feature. The instructions also cause the electronic computing system to after receiving the data selection input, determine whether the data selection input indicates that the user has selected particular data to be bound to the input property or a variable name. In addition, the instructions cause the electronic computing system to in response determining that the data selection input indicates that the user has selected particular data to be bound to the input property, automatically update a workflow template such that a plurality of activity elements in the workflow template includes a first activity element, each activity element in the plurality of activity elements indicating an activity in the structured set of activities, the first activity element indicating the selected activity, the first activity element including a first attribute, the first attribute associated with the input property of the selected activity, the first attribute specifying the particular data. Furthermore, the instructions cause the electronic computing system to in response to determining that the data selection input indicates that the user has selected the variable name, automatically update the workflow template such that the plurality of activity elements in the workflow template includes a second activity element, the second activity element indicating the selected activity, the second activity element including a second attribute, the second attribute associated with the input property of the selected activity, the second attribute specifying the variable name. Moreover, the instructions cause the electronic computing system to store the workflow template at a data storage system. The instructions also cause the electronic computing system to after storing the workflow template, store a workflow customization table at the data storage system, the workflow customization table including an entry indicating data to be bound to the variable name. In addition, the instructions cause the electronic computing system to, after storing the workflow customization table, receive a resource request from a client computing system. Furthermore, the instructions cause the electronic computing system to, in response to the resource request, automatically initialize a workflow instance, the workflow instance comprising the structured set of activities, the input property of the selected activity bound to the data indicated by the entry in the workflow customization table. In addition, after automatically initializing the workflow instance, the instructions cause the electronic computing system to automatically initiate execution of the workflow instance. During execution of the workflow instance, the instructions cause the electronic computing system to use data bound to the input property of the selected activity to execute the selected activity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for deploying workflows, the method comprising:
storing a workflow template at a data storage system, the workflow template defining a workflow, the workflow implementing a business process of an enterprise, the workflow comprising a structured set of activities, each activity in the structured set of activities being a modular set of computer-executable instructions that when executed perform a task in the business process, the workflow template comprising a plurality of activity elements, each activity element in the plurality of activity elements indicating an activity in the structured set of activities, the structured set of activities including a customizable activity, the customizable activity having an input property, the plurality of activity elements including a customizable activity element indicating the customizable activity, the customizable activity element including an attribute associated with the input property of the customizable activity, the attribute specifying a variable name;
after storing the workflow template, storing a workflow customization table at the data storage system, the workflow customization table including an entry indicating data to be bound to the variable name;
after storing the workflow customization table, receiving, at a server computing system, a resource request from a client computing system;
in response to the resource request, automatically initializing, at the server computer system, a workflow instance, the workflow instance comprising the structured set of activities, the input property of the customizable activity bound to the data indicated by the entry in the workflow customization table;
after automatically initializing the workflow instance, automatically initiating, at the server computing system, execution of the workflow instance; and
during execution of the workflow instance, using, at the server computing system, data bound to the input property of the customizable activity to execute the customizable activity.

2. The method of claim 1, wherein the workflow template is an extensible markup language (XML) file and each activity element in the plurality of activity elements is an XML element.

3. The method of claim 1,
wherein receiving the resource request from the client computing system comprises receiving, at the server computing system, a Hypertext Transfer Protocol (HTTP) request; and
wherein the method further comprises sending, by the server computing system, a HTTP response to the client computing system, the HTTP response responsive to the HTTP request, the HTTP response containing data generated by the server computing system when the server computing system executes the workflow instance.

4. The method of claim 3 wherein automatically initializing the workflow instance comprises automatically initializing, at the server computing system, the workflow instance in response to receiving the HTTP request.

5. The method of claim 1 further comprising:
displaying, by a design computing system, a graphic user interface (GUI), the GUI containing a plurality of available activity names, each available activity name in the plurality of available activity names being a name of an activity in a plurality of available activities, each activity in the plurality of available activities being available to be included in the workflow template;
after displaying the GUI, receiving, at the design computing system, activity selection input from a user via the GUI, the activity selection input indicating a selected available activity name in the plurality of available activity names, the selected activity name being a name of a selected activity in the plurality of available activities;
in response to the activity selection input, displaying, by the design computing system, a natural language sentence in the GUI, the natural language sentence expressing a task performed when the selected activity is executed, the natural language sentence including an input feature, the input feature enabling the user to select particular data to be bound to an input property of the selected activity or to select a variable name;
after displaying the natural language sentence receiving, at the design computing system, data selection input from the user via the input feature;
after receiving the data selection input, determining, at the design computing system, whether the data selection input indicates that the user has selected particular data to be bound to the input property of the selected activity or a variable name;
in response determining that the data selection input indicates that the user has selected particular data to be bound to the input property of the selected activity, automatically updating, at the design computing system, the workflow template such that the plurality of activity elements in the workflow template includes a first activity element, the first activity element indicating the selected activity, the first activity element including a first attribute, the first attribute associated with the input property of the selected activity, the first attribute specifying the particular data; and
in response to determining that the data selection input indicates that the user has selected the variable name, automatically updating, at the design computing system, the workflow template such that the plurality of activity elements in the workflow template includes a second activity element, the second activity element indicating the selected activity, the second activity element including a second attribute, the second attribute associated with the input property of the selected activity, the second attribute specifying the variable name.

6. The method of claim 5, wherein the input feature is a text entry feature.

7. The method of claim 1,
wherein the variable name is a first variable name; and
wherein the method further comprises:
after storing the workflow template and prior to storing the workflow customization table, displaying, by the server computing system, a workflow customization user interface, the workflow customization user interface containing a plurality of variable names, the plurality of variable names including each variable name specified by attributes of activity elements in the plurality of activity elements, the plurality of variable names including the first variable name;
after displaying the workflow customization user interface, receiving, at the server computing system, data selection input from a user via the workflow customization user interface, the data selection input indicating the data to be bound to the first variable name; and
in response to the data selection input, adding, at the server computing system, the entry to the workflow customization table.

8. The method of claim 7,
wherein the workflow template is a first workflow template;
wherein storing the first workflow template comprises storing the first workflow template in a file library on the data storage system, the file library containing resources of a website, the file library containing a plurality of workflow templates; and
wherein the method further comprises:
prior to receiving the data selection input, displaying, by the server computing system, a workflow template list in the workflow customization user interface, the workflow template list containing names of each workflow template in the plurality of workflow templates, the workflow customization user interface enabling the user to select one of the workflow templates in the plurality of workflow templates; and
prior to receiving the data selection input, receiving, at the server computing system, template selection input from the user via the workflow customization user interface, the template selection input indicating the first workflow template.

9. The method of claim 8,
wherein the plurality of workflow templates is a first plurality of workflow templates, the website is a first website, and the file library is a first file library;
wherein the method further comprises:
storing a second set of workflow templates in a second file library on the data storage system, the second file library containing resources of a second website, the second website being a sub-site of the first website; and
storing a third set of workflow templates in a third file library on the data storage system, the third file library containing resources of a third website, the third website being a sub-site of the first website;
wherein the workflow template list additionally contains names of each workflow template in the second set of workflow templates when the workflow customization table is stored in the second file library, but not names of the workflow templates in the third file library; and
wherein the workflow template list additionally contains names of each workflow template in the third set of workflow templates when the workflow customization table is stored in the third file library, but not names of the workflow templates in the second file library.

10. The method of claim 1, wherein the data indicated by the entry is a list, the list comprising a table of data.

11. The method of claim 1, wherein automatically initializing the workflow instance comprises binding contextual data to an input parameter of an activity in the plurality of activities, the contextual data defined by a context in which the workflow instance is initialized.

12. The method of claim 1,
wherein the data bound to the input property is an e-mail address; and
wherein using data bound to the input property of the customizable activity comprises sending an e-mail message that includes the e-mail address.

13. The method of claim 1,
wherein the workflow customization table is a first workflow customization table, the workflow instance is a first workflow instance, the entry is a first entry, and the resource request is a first resource request; and
wherein the method further comprises:
after storing the workflow template and while the first workflow customization table is stored at the data storage system, storing a second workflow customization table at the data storage system, the second workflow customization table including a second entry indicating data to be bound to the variable name;
after storing the second workflow customization table, receiving, at the server computing system, a second resource request;
in response to the second resource request, automatically initializing, at the server computer system, a second workflow instance, the second workflow instance comprising the structured set of activities, the input property of the customizable activity bound to the data indicated by the second entry in the second workflow customization table;
after automatically initializing the second workflow instance, automatically initiating, at the server computer system, execution of the second workflow instance; and
during execution of the second workflow instance, using data bound to the input property of the customizable activity to execute the customized activity.

14. An electronic computing system comprising:
a processing unit; and
a data storage system storing:
a workflow template, the workflow template defining a workflow, the workflow implementing a business process of an enterprise, the workflow comprising a structured set of activities, each activity in the structured set of activities being a modular set of computer-executable instructions that when executed perform a task in the business process, the workflow template comprising a plurality of activity elements, each activity element in the plurality of activity elements indicating an activity in the structured set of activities, the structured set of activities including a customizable activity, the customizable activity having an input property, the plurality of activity elements including a customizable activity element indicating the customizable activity, the customizable activity element including an attribute associated with the input property of the customizable activity, the attribute specifying a variable name;
a workflow customization table, the workflow customization table including an entry indicating data to be bound to the variable name; and
computer-executable instructions that, when executed by the processing unit, cause the electronic computing system to:
receive a resource request from a client computing system;
in response to the resource request, automatically initialize a workflow instance, the workflow instance comprising the structured set of activities, the input property of the customizable activity bound to the data indicated by the entry in the workflow customization table;
after automatically initializing the workflow instance, automatically initiate execution of the workflow instance; and
during execution of the workflow instance, use data bound to the input property of the customizable activity to execute the customizable activity.

15. The electronic computing system of claim 14 wherein the instructions further cause the electronic computing system to:
display a graphic user interface (GUI), the GUI containing a plurality of available activity names, each available activity name in the plurality of available activity names being a name of an activity in a plurality of available activities, each activity in the plurality of available activities being available to be included in a workflow;
receive activity selection input from a user via the GUI, the activity selection input indicating a selected available activity name in the plurality of available activity names, the selected activity name being a name of a selected activity in the plurality of available activities;
in response to the activity selection input, display a natural language sentence in the GUI, the natural language sentence expressing a task performed when the selected activity is executed, the natural language sentence including an input feature, the input feature enabling the user to select particular data to be bound to an input property of the selected activity or to select a variable name;
after displaying the natural language sentence, receive data selection input from the user via the input feature;
after receiving the data selection input, determine whether the data selection input indicates that the user has selected particular data to be bound to the input property of the selected activity or a variable name;
in response determining that the data selection input indicates that the user has selected particular data to be bound to the input property of the selected activity, update the workflow template such that the plurality of activity elements in the workflow template includes a first activity element, the first activity element indicating the selected activity, the first activity element including a first attribute, the first attribute associated with the input property of the selected activity, the first attribute specifying the particular data; and
in response to determining that the data selection input indicates that the user has selected the variable name, update the workflow template such that the plurality of activity elements in the workflow template includes a second activity element, the second activity element indicating the selected activity, the second activity element including a second attribute, the second attribute associated with the input property of the selected activity, the second attribute specifying the variable name.

16. The electronic computing system of claim 14,
wherein the variable name is a first variable name;
wherein the workflow template is a first workflow template; and
wherein the instructions cause the electronic computing system to store the first workflow template at least in part by causing the electronic computing system to store the first workflow template in a file library on the data storage system, the file library containing resources of a website, the file library containing a plurality of workflow templates; and
wherein the instructions further cause the electronic computing system to:
display a workflow template list in a workflow customization user interface, the workflow template list containing names of each workflow template in the plurality of workflow templates, the workflow customization user interface enabling the user to select one of the workflow templates in the plurality of workflow templates
receive template selection input from the user via the workflow customization user interface, the template selection input indicating the first workflow template;
after storing the workflow template and prior to storing the workflow customization table, display in the workflow customization user interface a plurality of variable names, the plurality of variable names including each variable name specified by attributes of activity elements in the plurality of workflow elements, the plurality of variable names including the first variable name;
after displaying the plurality of variable names, receive data selection input from the user via the workflow customization user interface, the data selection input indicating the data to be bound to the first variable name; and
in response to the data selection input, adding the entry to the workflow customization table.

17. The electronic computing system of claim 16,
wherein the plurality of workflow templates is a first plurality of workflow templates, the website is a first website, and the file library is a first file library;
wherein the instructions further cause the electronic computing system to:
store a second set of workflow templates in a second file library on the data storage system, the second file library containing resources of a second website, the second website being a sub-site of the first website; and
store a third set of workflow templates in a third file library on the data storage system, the third file library containing resources of a third website, the third website being a sub-site of the first website;
wherein the workflow template list additionally contains names of each workflow template in the second set of workflow templates when the workflow customization table is stored in the second file library, but not names of the workflow templates in the third file library; and
wherein the workflow template list additionally contains names of each workflow template in the third set of workflow templates when the workflow customization table is stored in the third file library, but not names of the workflow templates in the second file library.

18. The electronic computing system of claim 14, wherein the workflow template is an extensible markup language (XML) file and each activity element in the plurality of activity elements is an XML element.

19. The electronic computing system of claim 14,
wherein the instructions cause the electronic computing system to receive the resource request from the client computing system at least in part by causing the electronic computing system to receive a Hypertext Transfer Protocol (HTTP) request; and
wherein the instructions further cause the electronic computing system to:
initialize the workflow instance in response to receiving the HTTP request; and
send a HTTP response to the client computing system, the HTTP response responsive to the HTTP request, the HTTP response containing data generated by the server computing system when the server computing system executes the workflow instance.

20. A computer-readable medium comprising computer-executable instructions that, when executed by a processing unit of an electronic computing system, cause the electronic computing system to:
display a graphic user interface (GUI), the GUI containing a plurality of available activity names, each available activity name in the plurality of available activity names being a name of an activity in a plurality of available activities, each activity in the plurality of available activities being available to be included in a workflow, the workflow implementing a business process of an enterprise, the workflow comprising a structured set of activities, each activity in the structured set of activities being a modular set of computer-executable instructions that when executed perform a task in the business process;
receive activity selection input from a user via the GUI, the activity selection input indicating a selected available activity name in the plurality of available activity names, the selected activity name being a name of a selected activity in the plurality of available activities;
in response to the activity selection input, display a natural language sentence in the GUI, the natural language sentence expressing a task performed when the selected activity is executed, the natural language sentence including an input feature, the input feature enabling the user to select particular data to be bound to an input property of the selected activity or to select a variable name;
after displaying the natural language sentence, receive data selection input from the user via the input feature;
after receiving the data selection input, determine whether the data selection input indicates that the user has selected particular data to be bound to the input property or a variable name;
in response determining that the data selection input indicates that the user has selected particular data to be bound to the input property, automatically update a workflow template such that a plurality of activity elements in the workflow template includes a first activity element, each activity element in the plurality of activity elements indicating an activity in the structured set of activities, the first activity element indicating the selected activity, the first activity element including a first attribute, the first attribute associated with the input property of the selected activity, the first attribute specifying the particular data;
in response to determining that the data selection input indicates that the user has selected the variable name, automatically update the workflow template such that the plurality of activity elements in the workflow template includes a second activity element, the second activity element indicating the selected activity, the second activity element including a second attribute, the second attribute associated with the input property of the selected activity, the second attribute specifying the variable name;
store the workflow template at a data storage system;
after storing the workflow template, store a workflow customization table at the data storage system, the workflow customization table including an entry indicating data to be bound to the variable name;
after storing the workflow customization table, receive a resource request from a client computing system;
in response to the resource request, automatically initialize a workflow instance, the workflow instance comprising the structured set of activities, the input property of the selected activity bound to the data indicated by the entry in the workflow customization table;
after automatically initializing the workflow instance, automatically initiate execution of the workflow instance; and
during execution of the workflow instance, use data bound to the input property of the selected activity to execute the selected activity.
